(19) United States
(12) Patent Application Publication
(10) Pub. No.: US 2008/0225212 A1
(43) Pub. Date: Sep. 18, 2008

(54) Pixel designs for multi-domain vertical alignment liquid crystal display

(76) Inventor: Hiap L. Ong, Northborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/717,602

(22) Filed: Mar. 13, 2007

(51) Int. Cl. G02F 1/1343; G02F 1/1335; G02F 1/1337

(52) U.S. Cl. 349/106; 349/117; 349/130; 349/144

(57) ABSTRACT

An MVA display includes a plurality of repeats between a first substrate and a second substrate, each of which includes at least one full color pixel, and a drive circuit for driving the plurality of repeats. Each full color pixel includes at least one color dot for each of red, blue and green. Color dots contiguous between at least two adjoining repeats in a row have different colors from each other. Each color dot includes a common electrode, a pixel electrode and a liquid crystal component having a negative dielectric anisotropy between the common electrode and the pixel electrode. The common electrode is common among at least a portion of the repeats. The drive circuit causes color dots contiguous between at least two adjoining repeats in a row to have different polarities from each other.

### GOVERNMENT SUPPORT

The invention was supported, in whole or in part, by a grant, DAAB07-98-3-J032, from the U.S. Army Night Vision and Electronic Sensors Directorate (NVESD). The Government has certain rights in the invention.

### BACKGROUND OF THE INVENTION

The market for liquid crystal displays (LCDs) is increasing rapidly, especially in areas of large-area liquid crystal displays and television applications. The requirements for these applications include high resolutions, very high contrast levels, wide symmetrical viewing angles, and fast response times. In addition, very high contrast levels with respect to different viewing angles, gray-scale inversion, colorimetry, and optical response of an LCD are important factors of high-quality LCDs. The cost associated with designing and manufacturing these LCDs, based on the above-mentioned requirements, also needs to be considered.

Most conventional LCDs employ a 90° twisted nematic (TN) liquid crystal (LC) material in an LCD panel with polarizers attached outside. The drawbacks of conventional LCDs include narrow viewing angles (±40° horizontally and −15° and +30° vertically), slow response times (about 40 ms), large color dispersion, and difficulty in manufacturing high quality LCDs based on a conventional rubbing process. Another type of LCDs is a multi-domain vertical alignment (MVA) display. In particular, MVA active matrix LCDs can offer a normally black, very high contrast and wide symmetrical viewing angle performance. Controlling liquid crystal domains is the most important technology in obtaining a wide-viewing angle for vertically aligned LCDs. The conventional rubbing process is difficult to use for mass-production of multi-domain titled vertical electrically controlled birefringence LCD because of low-yield, high-cost multiple rubbing processes, unstable low-pre-tilt vertical alignment, and low contrast ratio for displays using a titled vertical LC alignment. In MVA displays, a vertical liquid crystal (LC) alignment with a rubbing-free zero-degree pre-tilt angle is generally used along with special surface geometries, such as a protrusion surface, ITO slit geometry, or a protrusion surface combined with an ITO slit geometry. These features can induce different tilt LC orientations in the field-on state and create a multi-domain LC response. The rubbing process is not required to obtain the zero-degree vertical LC alignment. Depending on single or double protrusion surfaces, either two-domain or four-domain MVA's can be created to improve the optical performances. Protrusions and ITO (indium-tin-oxide) slits contribute to an MVA-LCD having a low transmittance. Also, these protrusions and ITO slits contribute to a high cost of production. The combination of a protrusion surface with an ITO slit geometry provides another good control on the MVA-LCD, but requires a high cost process and also good alignment on the top and bottom substrates.

Therefore, there is a need for development of new MVA displays employing pixel designs that can minimize or eliminate one or more of the aforementioned problems associated with the conventional MVA using protrusion surface or ITO slit geometry.

### SUMMARY OF THE INVENTION

The present invention generally relates to new color pixel designs for LCDs, such as MVA displays.

In one embodiment, the present invention is directed to an MVA display that includes a plurality of repeats between a first substrate and a second substrate, and a drive circuit for driving the plurality of repeats. Each repeat includes at least one full color pixel. Each full color pixel includes one color dot for each of red, blue and green. Each contiguous color dot of at least two adjoining repeats in a row has a different color from each other. Each color dot includes a common electrode, a pixel electrode and a liquid crystal component having negative dielectric anisotropy between the two substrates. The common electrode is common among at least a portion of the repeats. The drive circuit causes each color dot of at least two adjoining repeats in a row to have polarities different from the polarities of contiguous color dots of the two adjoining repeats.

In another embodiment, the present invention is directed to a method of preparing an MVA display, such as the MVA display described above. The method includes forming a plurality of repeats between a first substrate and a second substrate, each of which includes at least one full color pixel, and forming a drive circuit causing each color dot of at least two adjoining repeats in a row to have polarities different from the polarities of contiguous color dots of the two adjoining repeats. Each full color pixel includes at least one color dot for each of red, blue and green. Each color dot of at least two adjoining repeats in a row has colors different from the colors of contiguous color dots of the two adjoining repeats. Each color dot includes a common electrode, a pixel electrode and a liquid crystal material having a negative dielectric anisotropy between the two substrates.

The MVA displays of the invention can employ a regular normal substrate, i.e., without special surface geometries, such as protrusions and ITO slits. This can result in significantly lower-cost fabrication processes and designs for manufacturing MVA displays, because the multi-domain LC response can be achieved without special surface geometries, such as protrusions and ITO slits. This is a substantial advantage, especially in microdisplays where such protrusions and ITO slits are extremely difficult to fit within the small pixel structures of the microdisplays, for example, MVA displays with about 15 μm×about 15 μm pixel size. The MVA displays of the invention can provide high contrast and wide viewing angles. The MVA displays of the invention, employing new color pixel designs, can be operated without substantial boundary stick and with substantially high optical transmission.

The MVA displays of the invention can be used for a variety of applications including electronic viewfinders for camcorders and digital cameras, and portable video eyewear to watch movies, music video and sporting events, and playing games, such as head-mounted displays, devices for watching DVDs or digital RV, mobile computing, and playing 3-D video games on lightweight eyewear systems.

### BRIEF DESCRIPTION OF THE DRAWINGS

FIG. 1A shows a schematic cross-sectional view of an MVA display of the invention.

FIG. 1B shows a top view of the MVA display of FIG. 1A taken along the B-B′ line.

FIG. 2A shows repeats of full color pixels of one embodiment of MVA pixel designs of the invention (“M10 design”).

FIG. 2B shows a full color pixel of the repeats of FIG. 2A.

FIG. 2C shows another embodiment of the arrangements of red (R), green (G) and blue (B) color dots having the M10 design scheme of FIG. 2A.

FIG. 3A shows repeats of full color pixels of one embodiment of MVA pixel designs of the invention (“M8 design”).

FIG. 3B shows a full color pixel of the repeats of FIG. 3A.

FIG. 4A shows repeats of full color pixels of one embodiment of MVA pixel designs of the invention (“M9 design”).

FIG. 4B shows a full color pixel of the repeats of FIG. 3A.

FIG. 5A illustrates a vertical LC molecule orientation when an MVA display of the invention is in the “field-off” state.

FIG. 5B illustrates a vertical LC molecule orientation when an MVA display of the invention is in the “field-on” state.

FIG. 6 is a schematic of three types of driving schemes for the MVA displays of the invention.

FIG. 7 shows a particular 4-domain pixel image of an MVA display having a plurality of repeats as shown in FIGS. 2A-2C, under pixel inversion with crossed-polarizers.

FIG. 8A shows a drive-scheme architecture that can be employed in the MVA displays of the invention.

FIG. 8B is a timing diagram that illustrates operation of the ac-coupled drive scheme of FIG. 8A.

FIG. 9 shows a block diagram of an MVA display of the invention.

FIG. 10 shows a head-mounted MVA display of the invention.

FIG. 11 shows 3-D calculated optical transmission versus voltage of an MVA display having a plurality repeats as shown in FIGS. 2A and 2B (“M10 pixel design”).

FIG. 12 shows 3-D calculated optical transmission versus voltage of an MVA display having a plurality repeats as shown in FIGS. 4A and 4B (“M9 pixel design”).

FIG. 13 shows 3-D calculated optical transmission versus voltage of an MVA display having a plurality repeats as shown in FIGS. 3A and 3B (“M8 pixel design”).

FIG. 14 shows measured brightness improvement for five displays having three different backlight designs utilizing LED light sources, bright enhancement films (B) and diffusers (D): LED+D+B+B (filled triangle); LED+D+D+B+B (filled square); LED+B+D (filled diamond).

FIG. 15 shows measured contrast ratio improvement for the five displays of FIG. 14.

### DETAILED DESCRIPTION OF THE INVENTION

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

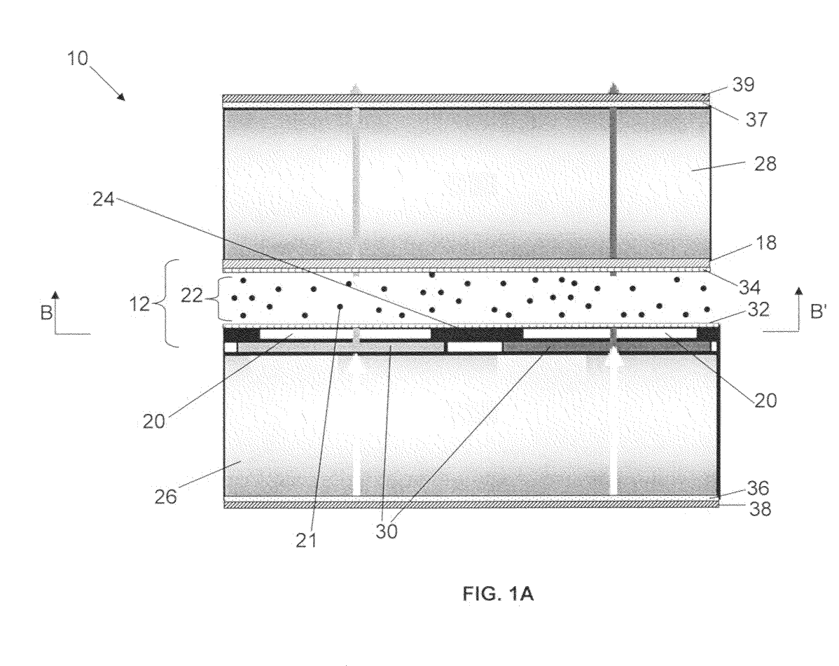

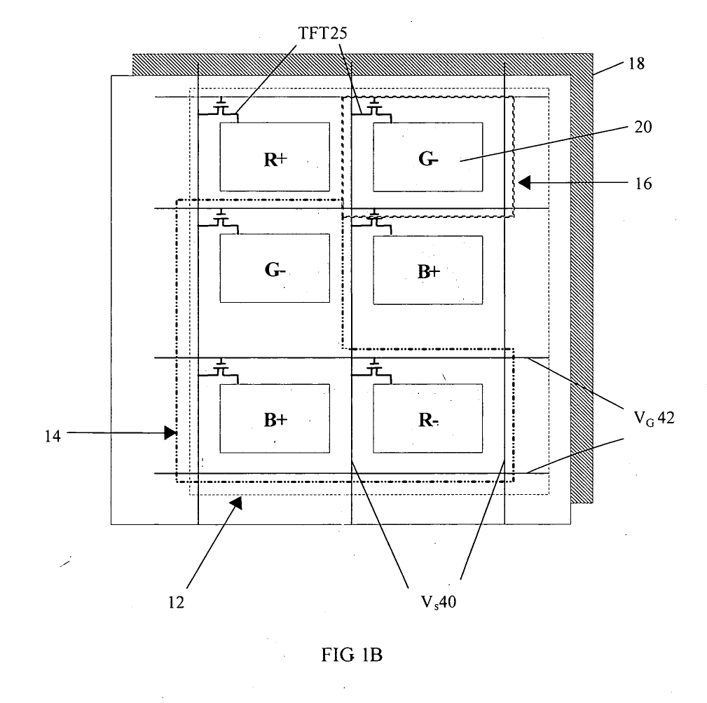

FIGS. 1A and 1B show one embodiment of the MVA displays of the invention. FIG. 1A shows a cross-sectional view of MVA display 10 of the invention. FIG. 1B shows a top view of MVA display 10 of FIG. 1 A, taken along line 1B-1B′ of FIG. 1A. MVA display 10 of the invention includes a plurality of repeats 12 between first substrate 26 and second substrate 28, and drive circuit 24. As shown in FIG. 1B, each repeat 12 includes at least one full color pixel 14. Each full color pixel 14 includes at least one color dot 16 for each of red, blue and green. Each color dot 16 of full color pixels 14 includes common electrode 18, pixel electrode 20, LC component 21 between common electrode 18 and pixel electrode 20. As used herein, LC component 21 refers to a portion of LC material 22, which is covered by pixel electrode 20. Common electrode 18 is common among at least a portion of repeats 12. Pixel electrodes 20 are at substrate 26, and common electrode 18 is at substrate 28. MVA display 10 shown in FIG. 1A also includes color filters 30 and first vertical LC alignment layer 32 at substrate 26 and second vertical LC alignment layer 34 at substrate 28. Also included in MVA display 10 are optical compensation films 36 and 37, and polarizer layers 38 and 39.

As used herein, the term “dot” refers to a minimum unit of display. Typically, in an active matrix LC display, a dot is defined by a pixel electrode and a common electrode opposing the pixel electrode. Alternatively, in an active matrix LC display, each intersection region between gate line (V_{G} 42) and source line (Vₛ 40) that is provided perpendicular to the gate line is defined as a dot. As a minimum unit of display, as shown in FIG. 1B, there is no direct contact between pixel electrodes. Rather, each pixel electrode is electrically connected with gate line V_{G} 42 and source line Vₛ 40 through the drain pixel electrode of transistor 25.

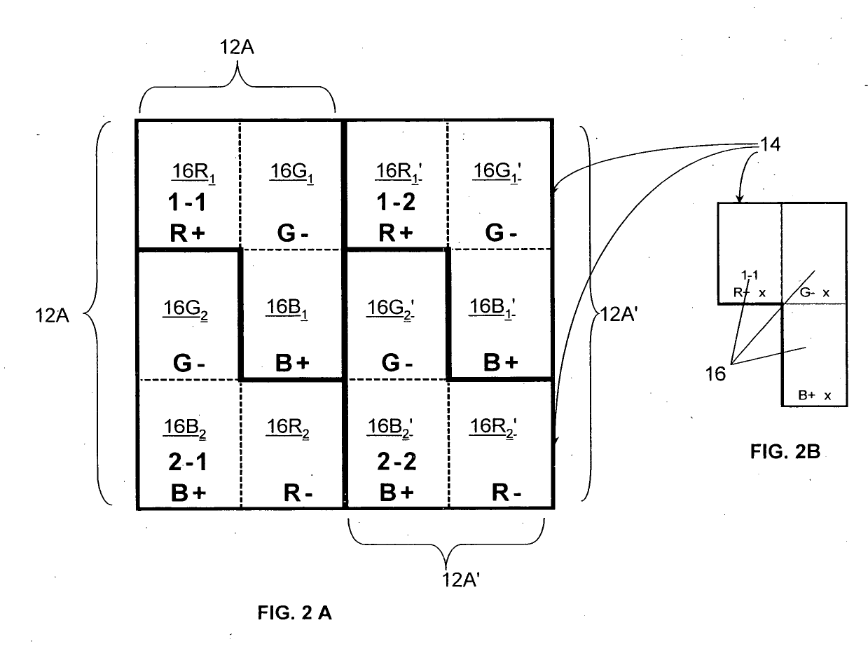

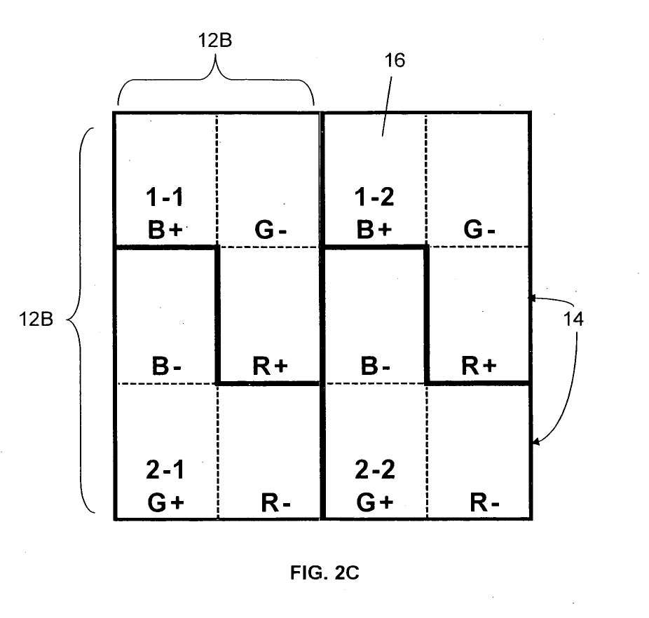

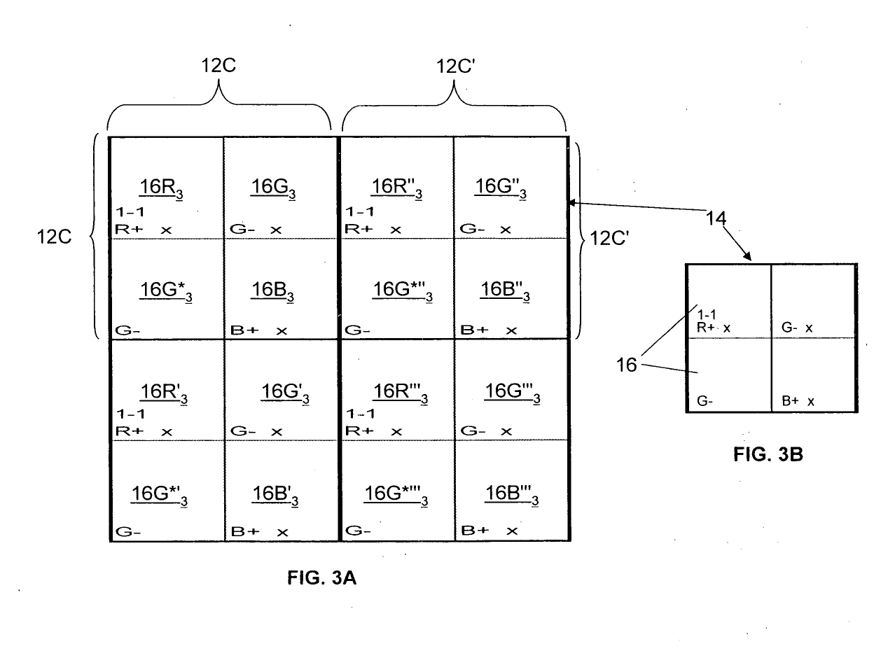

Specific embodiments of repeat 12 (repeats 12A-12D are collectively referred to repeats 12) are shown in FIGS. 2A-2C, 3A-3B and 4A-4B. In FIGS. 2A-2C, 3A-3B and 4A-4B, the characters “R,” “G,” “B” and “W” mean red, green, blue and white, respectively. Each of red, green, blue or white can be achieved by appropriate color filter 30 or by an appropriate backlight, or by a combination of these. For example, white color can be achieved by a color filter layer having red, green and blue filters. The characters “+” and “−” indicate polarities of dots 16 (dots 16R₁, 16G₁, etc. are collectively referred to dots 16). As shown in FIGS. 2A and 3A, at least two adjoining repeats 12 (e.g., repeats 12A and 12A′ shown in FIG. 2A, or repeats 12C and 12C′ shown in FIG. 3A) in a row have color dots contiguous between the adjoining repeats (hereinafter “contiguous color dots”), e.g., 16G₁ of repeat 12 A and 16R₁′ of repeat 12 A′; 16B₁ of repeat 12A and 16G₂′ of repeat 12 A′; 16R₂ of repeat 12A and 16B₂′ of 12A′; 16G₃ of repeat 12 C and 16R″₃ of repeat 12 C′; or 16B₃ of repeat 12C and 16G*″ of 12C′. Each of the contiguous color dots of at least two adjoining repeats has polarities and colors different from each other. For example, color dot 16G₁ of repeat 12A has polarity and color different from those of its contiguous color dot 16R₁′ of repeat 12A′ (see FIG. 2A). Similarly, color dot 16G₃ of repeat 12C has polarity and color different from those of its contiguous color dot 16R″₃ of repeat 12C′ (see FIG. 3A). In some embodiments, at least one color dot 16 of at least one repeat 12 has a different polarity from the polarity of all neighboring contiguous dots thereof, as shown in FIG. 3A (e.g., dot 16B₃ versus dots 16G₃, 16G′₃, 16G*₃ and 16G*″₃).

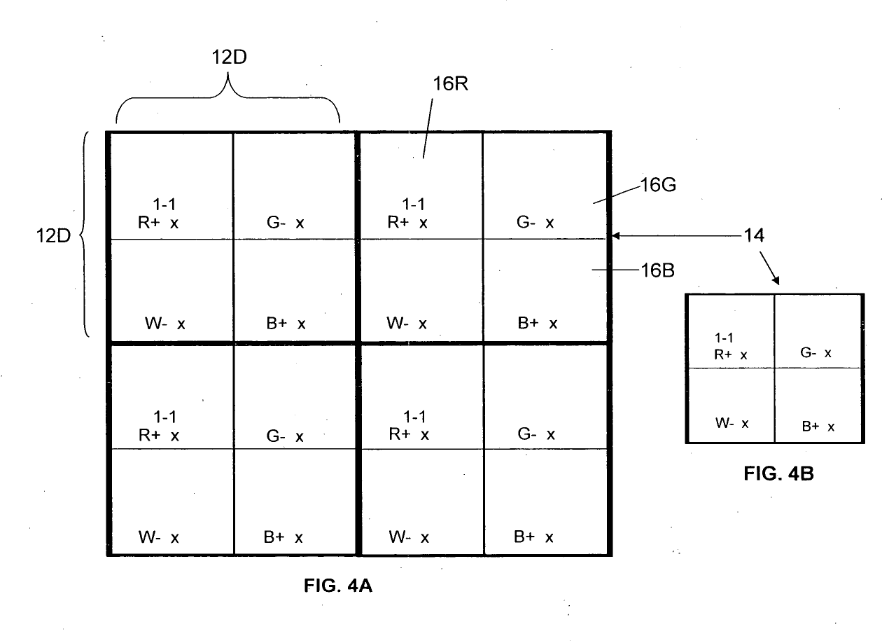

Each repeat 12 can have one full color pixel 14, as shown in FIGS. 3A-3B and 4A-4B. Alternatively, each repeat 12 can have more than one full color pixel 14, such as two (see FIGS. 2A and 2C) or three (not shown). When each repeat 12 has more than one full color pixel, e.g., two full color pixels 14 as shown in FIGS. 2A and 2C, each of full color pixels 14 preferably is complementary to each other in shape. For example, the full color pixels 14 in combination can form a square, rectangle or hexagon.

Full color pixel 14 can have any shape. Preferably, full color pixel 14 is in an L-shape or a quadrilateral. In a specific embodiment, full color pixel 14 is in an L-shape, as shown in FIGS. 2A-2C. In a more specific embodiment, the L-shaped full color pixel consists essentially of three color dots, i.e., one red color dot, one green color dot and one blue color dot. FIGS. 2A and 2C show two different arrangements of such red, green and blue color dots, forming L-shaped full color pixel 14.

In another specific embodiment, full color pixel 14 is a quadrilateral, such as a trapezoid or parallelogram, as shown in FIGS. 3A-3B and 4A-4B. Preferably, the quadrilateral full color pixel consists essentially of four color dots. In a more specific embodiment, the quadrilateral full color pixel includes two color dots for one of red, blue or green, and one color dot of the other each of red, blue and green. For example, as shown in FIGS. 3A-3B, the quadrilateral includes two green color dots, one red color dot and one blue color dot. In another more specific embodiment, the quadrilateral full color pixel includes white, red, green and blue color dots (see FIGS. 4A-4B).

In a preferred embodiment, each color dot 16 of full color pixel 14 has a plan dimension on each side of between about 3 μm and about 50 μm. More preferably, each color dot 16 has dimensions between about 5 μm×about 15 μm and about 15 μm×about 15 μm, such as about 7.5 μm×about 10 μm or about 7.5 μm×about 7.5 μm.

Referring back to FIGS. 1A and 1B, any type of common electrodes and pixel electrodes known in the art can respectively be used for common electrode 18 and pixel electrode 20 of the invention. In one embodiment, at least one of common electrode 18 and pixel electrode 20 is a planar electrode. In a specific embodiment, each pixel electrode 20 of each color dot 16 is planar. In a preferred embodiment, both common electrode 18 and each pixel electrode 20 are planar electrodes. As used herein, the term “planar electrode” means an electrode having an essentially flat surface (e.g., without the protrusion surface and ITO slit geometry) toward LC material 22 throughout the electrode. In a more preferred embodiment, each color dot 16 has a plan dimension as described above, and includes planar common electrode 18 and planar pixel electrode 20. Each pixel electrode 20 in the invention can have any shape. Preferably, each pixel electrode 20 is essentially a quadrilateral, more preferably essentially a rectangle, and even more preferably essentially a square.

Electrodes for the invention can be formed by, for example, any suitable method known in the art. For example, electrodes can be made from a poly-crystal silicon layer or transparent conductive material such as indium tin oxide, or other metal oxides such as titanium dioxide or zinc oxide. Conductive nitrides, such as aluminum nitride, for example, can also be used. These electrodes can be formed prior to transfer of drive circuit 24, such as an active matrix circuit, onto a transparent substrate. Alternatively, the pixel electrodes can be formed after transfer of the active matrix circuit onto a transparent substrate, and vias (e.g., Vs 40 and V_{G} lines 42) are formed through an insulating layer on which transistor circuits are formed to conductively connect pixel electrodes 20 to their respective switching transistors. This can permit pixel electrodes to be fabricated over the transistor circuits. Typically, each pixel electrode 20 has a thickness in a range of between about 10 nm and about 20 nm, and common electrode 18 has a thickness in a range of between about 50 nm and about 200 nm.

In some embodiments, liquid crystal (LC) material 22 has negative dielectric anisotropy. Various types of such LC materials are commercially available, for example, from Merck KGaA in Germany, such as Merck MLC-6608, MLC-6609, MLC-6610, MLC-6682, MLC-6683, MLC-6684, MLC-6685 and MLC-6686. LC material 22 is typically positioned between substrates 26 and 28. Typically, the distance between the substrates 26 and 28 (or a cell gap), sandwiching LC material 22, is less than about 5 μm, preferably in a range of between about 2 μm and about 4 μm, or less than about 3.5 μm.

Any transparent substrates known in the art can be used for substrates 26 and 28 in the invention. Suitable examples of substrates 26 and 28 include glass, fused silica, sapphire and transparent plastics.

In some preferred embodiments, as shown in FIG. 1A, each color dot 16 further includes color filter 30 of red, blue or green. Color filter 30 can be positioned at either substrate 26 or 28. For example, color filter 30 can be placed at substrate 26, such as between substrate 26 and pixel electrode 20 (see FIG. 1A) or under substrate 26 (not shown). In one preferred specific embodiment, color filters 30 are placed at substrate 28, for example, between common electrode 18 and substrate 28. Alternatively, MVA display 10 can employ a color sequential system where such color filters may not be necessary. Any suitable color filter materials can be used in the invention, for example, color filter materials available from Japan Dai Nippon Printing and Toppan Printing.

The vertical alignment of LC material 22 disposed between first and second substrates 26 and 28 can be achieved by, for example, any suitable method known in the art. Preferably, the vertical alignment of LC material 22 is achieved without rubbing. In a specific embodiment, each of substrates 26 and 28 includes an alignment layer that can align LC material 22 vertically with a zero-degree pre-tilt angle. Such an alignment layer (e.g., alignment layers 32 and 34 in FIG. 1A) can be formed by treating each of substrates 26 and 28 with one or more LC alignment materials such that a vertical LC alignment with a zero-degree pre-tilt angle is created without rubbing. Types of LC alignment materials used in this process are commercially available. Examples of such alignment materials include polyimide (PI) materials, such as SE-7511L, SE-1211 and RN-1566, which are available from Japan Nissan Chemical Industrial Ltd. Other suitable vertical alignment materials are also available from JSR Corporation in Japan, such as JALS-2096-R14, JALS-2136-R16, JALS-688-R11, AL1H659, and AL60101. The alignment layer can also be fabricated by a suitable photo-alignment process, as described in “Optical patterning of multi-domain LCDs” by M. Schadt and H. Seiberie, SID Digest, 397 (1997), the entire teachings of which are incorporated herein by reference. The alignment layer can also be fabricated by a suitable vacuum evaporation of SiOₓ and SiO₂ materials.

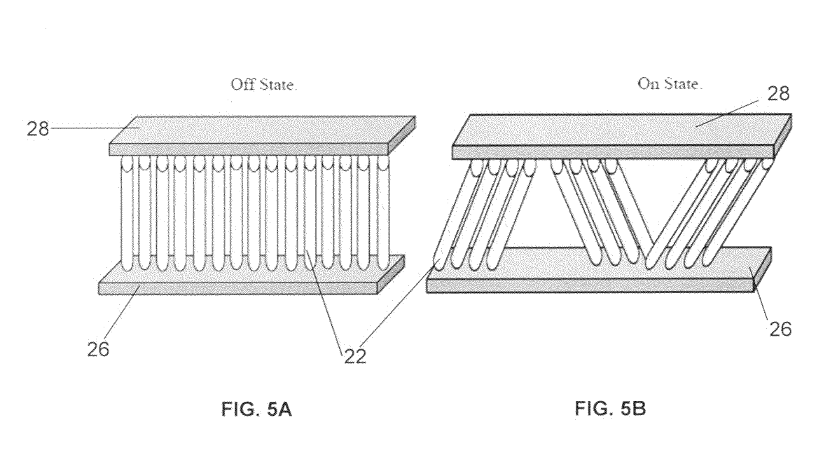

Referring to FIGS. 5A and 5B, an electric field is applied between the first and second substrates 26, 28 to switch LC material 22 from an initial vertical orientation (FIG. 5A) to a tilted orientation (FIG. 5B), and a fringe field associated with each dot is used to control the LC tilt direction and to create multi-domains. Shown in FIG. 5A is a “field-off” state that occurs when no electric field is applied between first and second substrates 26 and 28, and where the LC molecules of LC material 22 orient vertically. Shown in FIG. 5B is a “field-on” state that occurs when an electric field is applied between first and second substrates 26 and 28, and where the LC molecules of LC material 22 have tilted orientations. Thus, in a “field-on” state, the fringe field associated with the applied electric field switches the LC molecules from the initial vertical orientation to a tilted orientation. In general, there is no preferred alignment direction on the tilt angle in the “field-on” state if there is not fringe field for the LCs with a zero-degree pretilt vertical alignment.

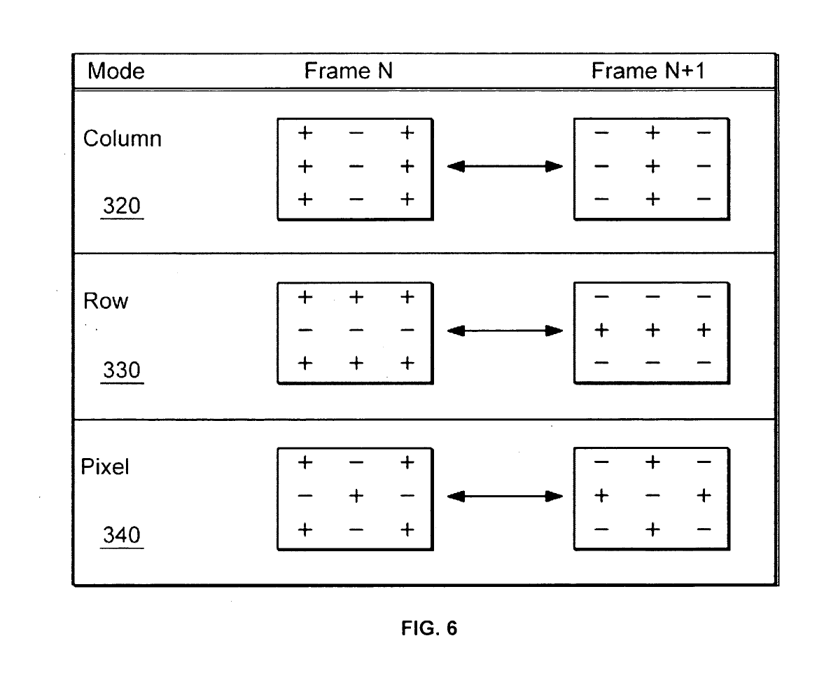

In one embodiment, the LC tilt direction of LC molecules of each dot 16 in a “field-on” state is controlled by the direction of the electric fringe field in each dot 16. The fringe field direction depends on the electrical field polarities of neighboring dots. For example, as shown in FIG. 6, column inversion 320, row inversion 330 and pixel inversion 340 schemes can be used in the invention. Such driving schemes are detailed in U.S. 2004/0201807 A1, the entire teachings of which are incorporated herein by reference. Preferably, in this embodiment, common electrode 18 is planar, i.e., without any protrusions on its surface toward LC material 22. More preferably, both common electrode 18 and each pixel electrode 20 of each dot 16 are planar.

A 2-domain MVA profile can be obtained under row inversion 330 and column inversion 320 driving schemes while a 4-domain MVA profile can be obtained under the pixel inversion driving scheme 340. A multi-domain profile, such as a 2 or 4 MVA domain profile, can be obtained by alternating between the pixel inversion driving scheme 340 and the column inversion driving scheme 320 or row inversion driving scheme 330.

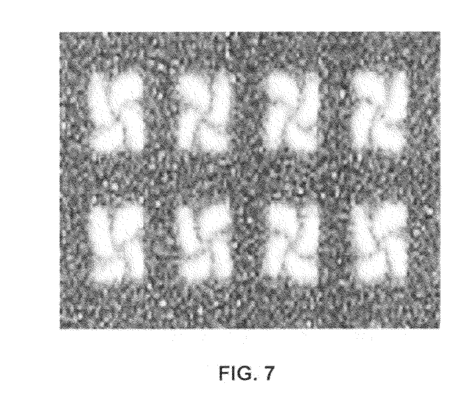

Using the pixel inversion driving scheme 340, each dot has a different polarity with respect to its 4 adjacent dots, that is, the left, right, up and down dots. Thus, in each dot, under the fringe field effect, four different domains are formed in the left, right, up, and down dot regions, where the LC molecules in the left, right, up, and down domains tilt in the left, right, up, and down directions respectively. FIG. 7 shows a particular 4-domain pixel image, under pixel inversion with crossed-polarizers.

Using the column inversion driving scheme 320, each dot has a different polarity with respect to its adjacent left and right dots. Thus, in each dot, under the fringe field effect, two different domains are formed in the left and right dot regions, where the LC molecules in the left domain tilt in the left direction and the LC molecules in the right domain tilt in the opposite right direction.

Using the row inversion driving scheme 320, each dot has a different polarity with respect to its adjacent up and down dots. Thus, in each dot, under the fringe field effect, two different domains are formed in the up and down dot regions, where the LC molecules in the up domain tilt in the up direction and the LC molecules in the down domain tilt in the opposite down direction.

Referring back to FIGS. 1A and 1B, drive circuit 24 includes one or more transistors. In a preferred embodiment, MVA display 10 of the invention is an active matrix LC display, preferably equipped with a thin-film transistor 25 (TFT) in each dot 16, as shown in FIG. 1B. Alternatively, MVA display 10 of the invention can also be an active matrix LC display using MIMs (Metal-Insulator-Metal) or a passive matrix LC display. TFT 25 can be fabricated by any suitable method known in the art, for example, by the methods described in U.S. Pat. Nos. 5,206,749, 5,705,424 and 6,608,654, the entire teachings of which are incorporated herein by reference.

ICs (integrated circuits) known in the art can be employed for drive circuit 24 of the invention. Preferably, a CMOS (Complementary Metal-Oxide-Semiconductor) driver utilizing a single crystal silicon-on-insulator (SOI) starting material is employed in the invention. Such a CMOS can be driven by a dc common drive scheme or by an ac-coupled drive scheme, known in the art, for example, in Richard, A. and Herrmann, F. P., “A New Drive Scheme Architecture for AMLCDs Used in Microdisplays,” Information Display, pp 14-17 (2005), the entire teachings of which are incorporated herein by reference. For example, the CMOS can be driven by an ac-coupled drive scheme. In this scheme, Vₛ can be tied to ground.

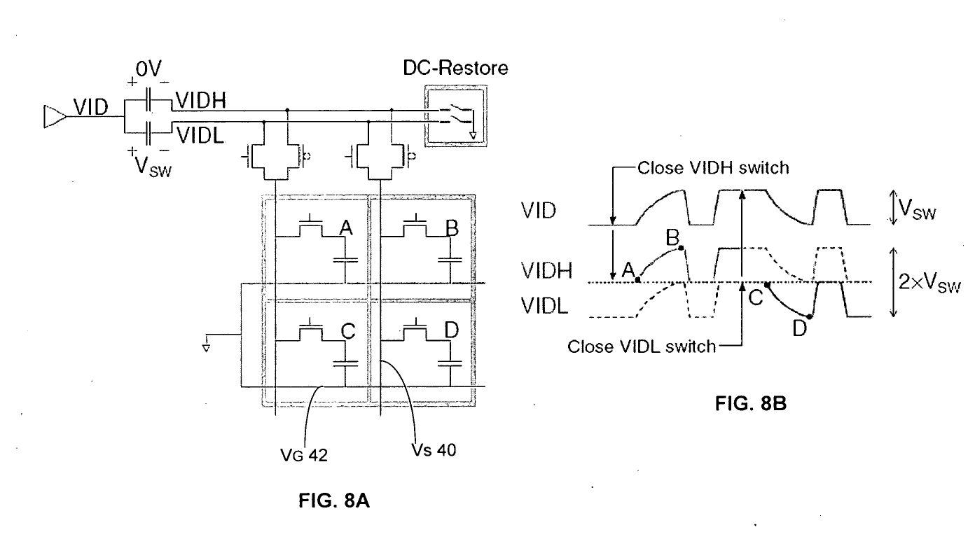

Referring to FIG. 8A, an example of ac-coupled drive schemes that can be used in the invention is shown in FIG. 8A. As shown in FIG. 8A, a single amplifier drives a source signal (identified in FIG. 8A as “VID”) with a swing of 1×Vsw. Two external capacitors couple the VID signal to the display input signals (identified in FIG. 8A as “VIDH” and “VIDL”). As shown in FIG. 8A, two video input pins are employed. Also, CMOS column drivers are split; the p-channel transistor is connected to VIDH and the n-channel transistor is connected to VIDL. Only one transistor of the pair is activated at a time. The dc-restore switches shown in FIG. 8A are preferably added to maintain the desired voltages across the coupling capacitors. FIG. 8B shows a timing diagram that illustrates operation of the ac-coupled drive scheme of FIG. 8A. For example, the VID signal is kept low at the beginning of the first row, while the dc-restore switch for VIDH is closed briefly to set 0 V across the VIDH coupling capacitor. Color dots A and B are written to black (i.e., light does not pass through the LCD display) and white (i.e., light passes through the LCD display and color can be viewed), respectively, using the p-channel column-drive transistors. The polarity of VID is inverted before the second row is written, so VID is held at high while the switch to VIDL is closed. This sets the VIDL capacitor voltage to Vsw. The n-channel column drivers are then activated to write color dot C to black and color dot D to white with −Vsw, as shown in FIG. 8B. The VID polarity is switched again at the end of the row, in preparation for the DC restore of VIDH.

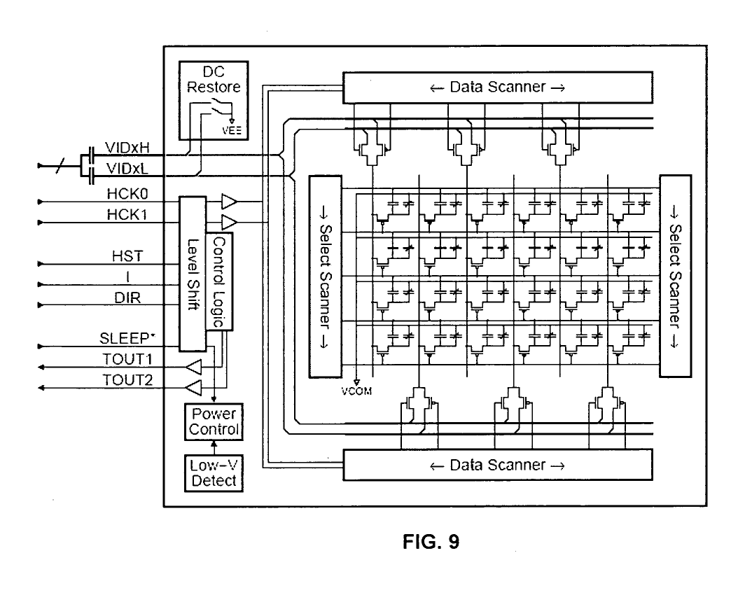

Referring to FIG. 9, the block diagram corresponds to an MVA display of the invention. In FIG. 9, external capacitors couple 16 video signals to the display's 32 video inputs. Integrated scanners drive the pixel array. Two bi-directional horizontal data scanners switch the video inputs onto the column lines. The bi-directional vertical scanners select rows one by one, driving from both ends of each row line. The input level shift circuits accept digital control signals with, e.g., 3.3-volt levels. An internal power down reset circuit can be used to equalize charge in the pixel array before power is removed from the display to prevent image retention and/or flicker upon restoration of power. An internal heater can also be integrated into the display to support a warm up mode. During the warm up mode, current flows from one vertical scanner across the display through, e.g., a resistive polysilicon row lines to another vertical scanner.

In some preferred embodiments, the MVA displays of the invention include one or more backlight sources. Any suitable backlight sources known in the art can be used in the invention. In a preferred embodiment, the MVA displays of the invention include a plurality of LED sources, such as red, green and blue LED sources. In a more preferred embodiment, the MVA displays of the invention further include one or more diffusers (D) and/or one or more brightness enhancement films (B). Suitable examples of diffusers include USA 3M, Japan Omron and Nitto Denko. Suitable examples of brightness enhancement films include USA 3M and Japan Nitto Denko.

The MVA-LCD of the present invention can provide high contrast, for example, between about 50:1-10000:1 contrast along the diagonals and the horizontals, symmetrical viewing-angle LC optical performance, improved gray scale operation, and an improved small gray scale reverse region. Also, a wide symmetrical viewing angle, for example greater than about 160° (±80°) in the horizontal and vertical viewing zones, can be obtained by the MVA displays of the invention. Further, the viewing angle of the MVA-LCD can be further improved by the use of optical compensation films (e.g., optical compensation films 36 and 37 shown in FIG. 1A), such as a negative birefringence anisotropic optical film (e.g., an optical anisotropic film, or optical compensation film made of a low or high molecular liquid crystalline compound) with a vertical optical axis. Both uniaxial and biaxial optical compensation films, with a positive or negative birefringence, or composite film with positive birefringence and negative birefringence, can be used to improve the viewing angle for the MVA-LCD. Furthermore, the optical axis can either be vertical, parallel, tilted, or a composite film with a variable optical axis structure. For example, an optical compensation film with an ordinary refractive index nₒ=1.51, extra-ordinary refractive index nₑ=1.50, thickness d=19.4 μm, (nₑ−nₒ)×d=−194 nm, and a vertical optical axis can be applied to substrates 26 and 28 to improve performance.

Referring back to FIG. 1A, polarizer layers 38 and 39 can be included in the MVA displays of the invention. In a preferred embodiment, polarizer layers 38 and 39 are attached in a crossed geometry.

The MVA displays of the invention can be transmissive-type LCDs, reflective-type LCDs, or transflective-type LCDs.

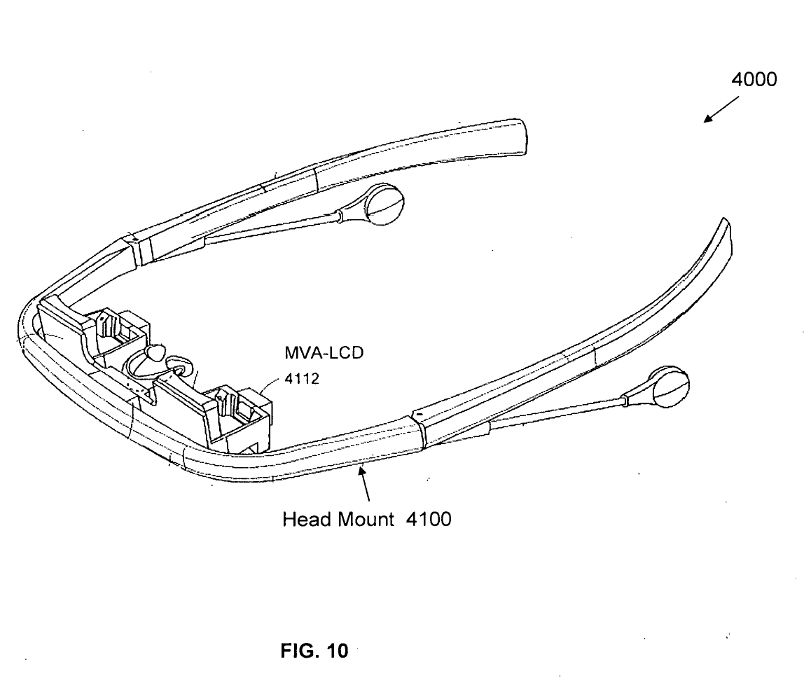

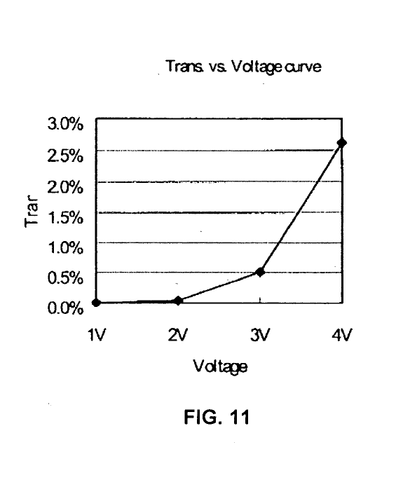

In a preferred embodiment, the MVA displays of the invention are head-mounted displays, employing head mounts as described in U.S. Pat. Nos. 5,815,126; 6,452,572; 6,421,031; 6,448,944 and 6,424,321, the entire teachings of which are incorporated herein by reference. Head-mounted MVA display 4000 of the invention is shown in FIG. 10, including head mount 4100 and MVA-LCD 4112.

The MVA displays of the invention can have any suitable display resolution, such as a display resolution of QVGA (320×240×3 dots), VGA (640×480×3 dots), SVGA (800×600×3 dots), or SXGA (1280×1024×3 color dots). Preferably, the MVA displays of the invention has a display resolution of at least 320×240×3 dots.

The optical transmission of the MVAs of the invention can be improved by a higher drive voltage, LC's with a lower threshold voltage, LC's with a high birefringence value, a modified pixel design, and/or the use of circular polarizers.

The MVA displays of the invention can be fabricated by any suitable methods known in the art. For example, color filters are printed onto one of glass or plastic transparent substrates. Thin layers of electrode material(s), such as indium tin oxide (ITO) onto the substrates to form electrodes. A layer of alignment material such as polyimide is deposited onto the substrates. One or more spacers are placed between the substrates. LC molecules are placed into the gap between the top and bottom substrates by capillary action or vacuum injection. After the LC filled, the small opening for the LC fill is sealed by the end-seal materials. Polarizing layers are placed on both sides of the display.

The active matrix transistor circuits and pixel electrodes of the LCDs of the invention can be made by any suitable methods known in the art, for example by the methods discussed in the Seminar “Backplane design and technology for microdisplays” by Ian Underwood, SID 2002 Seminar Lecture Notes, Volume, Seminar M-13 (2002), by methods disclosed in U.S. Pat. Nos. 5,206,749, 5,705,424 and 6,608,654, the entire teachings of which are incorporated herein by reference. In one embodiment, the active matrix transistor circuits are made by the methods described in U.S. Pat. No. 5,206,749. As described in U.S. Pat. No. 5,206,749, the active matrix transistor circuits are formed in a single crystal Si material having a silicon-on-insulator (SOI) structure. The SOI structure can be fabricated using a number of techniques, including recrystallization of non-single crystal Si that has been deposited on a silicon dioxide layer formed on a single crystal Si substrate. This Si or other semiconductor substrate can be removed by etching after bonding of the circuit to a transparent substrate. Other methods for SOI structure fabrication, including the bonding of two wafers with an adhesive and lapping of one wafer to from a thin film and transfer of the thin film onto glass, or, alternatively, by implantation of oxygen into a silicon wafer, can also be used.

In one example, as described in U.S. Pat. No. 5,705,424, active matrix circuits for electronic displays can be fabricated in thin film single crystal silicon and transferred onto glass substrates for display fabrication. A transistor in an active matrix circuit can be formed with a thin film single crystal silicon layer over an insulating substrate. The areas or regions of the circuit in which pixel electrodes are to be formed are subjected to a silicon etch to expose the underlying oxide. A transparent conductive pixel electrode is then formed on or over the exposed oxide with a portion of the deposited electrode extending up the transistor sidewall to the contact metalization of the transistor. A passivation layer is then formed over the entire device, which is then transferred to an optically transparent substrate. The composite structure is then attached to a common electrode and polarization elements and an LC material are then inserted into the cavity formed between the oxide layer and the common electrode.

In another example, fabrication of active matrix pixel electrodes can be done after transfer of the active matrix circuit onto a transparent substrate and exposure of the backside of the insulator on which a thin film single crystal silicon was formed, as described in U.S. Pat. No. 5,705,424. In this process, a transferred active matrix circuit is prepared. Vias (e.g., Vₛ 40 and V_{G} 42 lines) are formed through the insulator to expose a contact area of the silicon in the transistor circuit. A conductive transparent electrode material is then deposited and patterned to make electrical contact to the transistor circuit through the vias and simultaneously form the pixel electrodes. An additional metal layer or other conductive material can be formed between the electrode material and the contact area to improve conductivity. A separate light shield region can also be formed on the second side of the circuit.

Table 1 shows an example of MVA displays that can be made by the invention.

TABLE 1
Color MVA display Parameters

| PARAMETER | 1280 × 1024 Full-Color Display |
|---|---|
| Display Type | Color AMLCD Transmissive, normally opaque |
| | MVA |
| Resolution | SXGA (1280 × 1024) full color |
| Color | 24-bit full color R, G, B color dots |
| Pixel Pitch | 15 um (H) × 15 um (V)1700 DPI |
| Sub-Pixel Pitch | 5 um (H) × 15 um (V) for each R, G, B color dot |
| Display Area | 19.2 mm × 15.6 mm (same as Monochrome |
| | 1280 × 1024 Display) |
| Viewing Angle | >40 degree cone (wider on axis) |
| Luminance Range | 0.1–150 ft-L |
| Contrast Ratio | >300:1 (On-Axis)/80:1 Off Axis |
| Color Gamut | ≧NTSC Color Performance |
| Flicker | −40 db |
| Pixel Cross Talk | <5% |
| Image Retention | <16 msec |
| Turn on Time | <33 msec |
| Frame Rate | 60 Hz |
| Response Time | <16 msec @35 C. |
| Aperture | >50% |
| Transmission | 3% long range target, 1.5% near term |
| Temperature Range | −37° C. to +65° C. |
| | (Includes temperature control heater) |
| Warm-up Time | <90 sec from −37° C.; new target of 15 sec |
| | using new heater |
| Backlight | R, G, B color system - Integrated module |
| Interface | Less than 40 wires total for video, clocks and power |
| Power | <1.0 W Including AMLCD, backlight, heater & |
| | ASIC drive electronics |

### EXEMPLIFICATION

### Example 1

### Display Fabrication

Generally, the MVA displays of the invention can be fabricated as described above. In one example, spin-coated polyimide (PI) (Nissan vertical alignment PIs SE-1211 and RN-1566) as the LC alignment layers, Merck LC MLC-6884, and a cell gap of 2.0-4.0 μm were used for the MVA display fortification. 1 to 6% PI was spin coated at the speed of 1000-4000 RPM. The PI-coated wafers first pre-cure on hot plate at 85° C. for 5 minutes, then final-cure in a vacuum oven for 150-200° C. for 60 minutes. A vertical LC alignment without any pretilt angle was obtained with such PI alignment layers. LCDs with such a polyimide layer generally passed the prolonged reliability test of 72 hours exposure to 85° C. in 85% relative humidity. The fabricated MVA showed a normally black operation, with a wide viewing angle and high contrast ratio.

### Example 2

### MVA Modeling

MVA display designs for a plurality of repeats can be modeled with both two-dimensional and three-dimensional models, such as Autronic 2-D LC Modeling software (2-D modeling) and Shintech 3-D LC Modeling software (3-D modeling). Geometrical optics approximation can be used for such modeling to make a fast estimation on the MVA electrical optical transmission. The modeling results can be used to understand and improve MVA operation, to help design the display pixel structure, and later compared to measurements from actual displays.

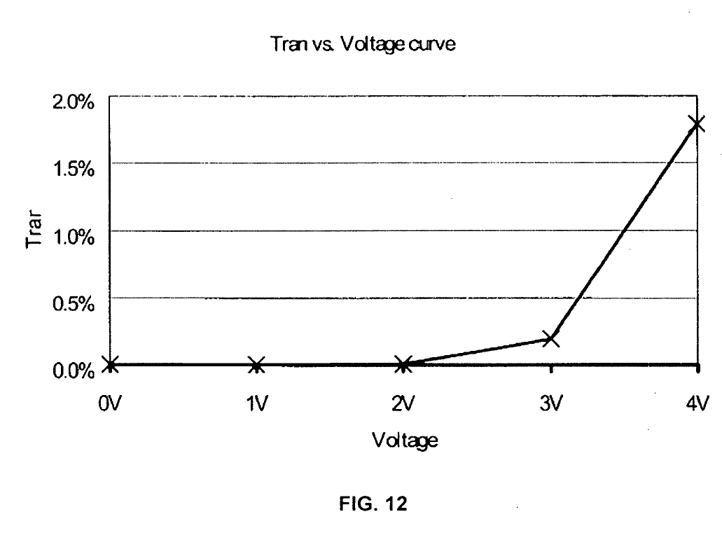

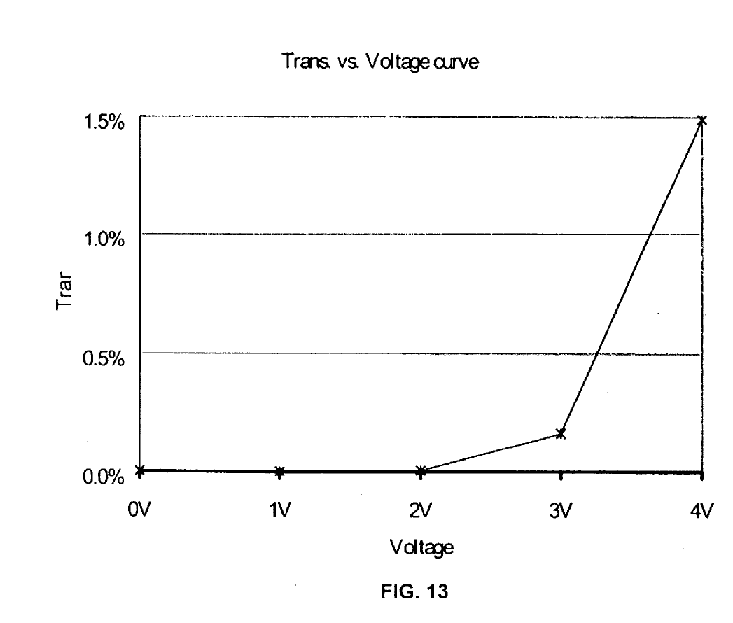

FIG. 11 shows 3-D calculated optical transmission vs. voltage of an MVA display having a plurality repeats as shown in FIGS. 2A and 2B (“M10 pixel design”). FIG. 12 shows 3-D calculated optical transmission vs. voltage of an MVA display having a plurality repeats as shown in FIGS. 4A and 4B (“M9 pixel design”). FIG. 13 shows 3-D calculated optical transmission vs. voltage of an MVA display having a plurality repeats as shown in FIGS. 3A and 3B (“M8 pixel design”). The 3-D modeling was done using Shintech 3-D LC Modeling software. In the M10 design, each color dot had the dimensions of 7.4 μm×10 μm. In the M9 and M8 designs, each dot had the dimensions of 7.5 μm×7.5 μm. As can be seen in FIGS. 11-13, the optical transmission of the MVAs was generally improved by a higher drive voltage.

### Example 3

### Display Performance

### A. Multi-Domain Creation

FIG. 7 shows a microphotograph of an image of an MVA display having a plurality repeats as shown in FIGS. 2A-2C with 1280×124×3 dot under a crossed polarizer geometry. As can be seen in FIG. 7, each dot showed four domains.

### B. Transmission and Contrast Ratio

Five different MVA displays were prepared with a QVGA resolution (320×240 dots) with a dot size of 15 um×15 um and used for testing different backlight designs utilizing LED light sources, different combinations of diffusers (D) and brightness enhancement films (B): LED+D+B+B; LED+D+D+B+B; LED+B+D. Brightness and contrast ratio of the five displays were tested by Kopin Corporation. The applied voltage was 4.5 volts.

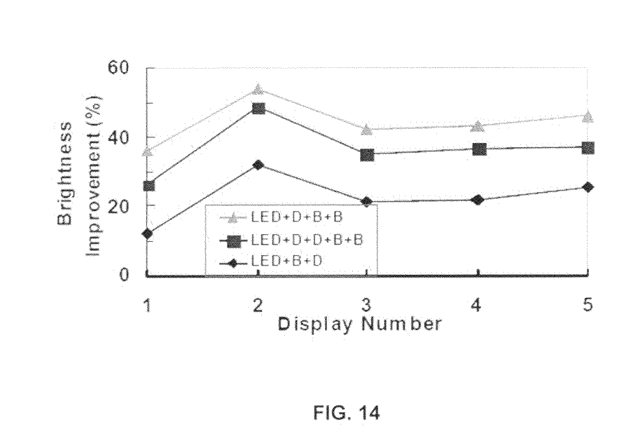

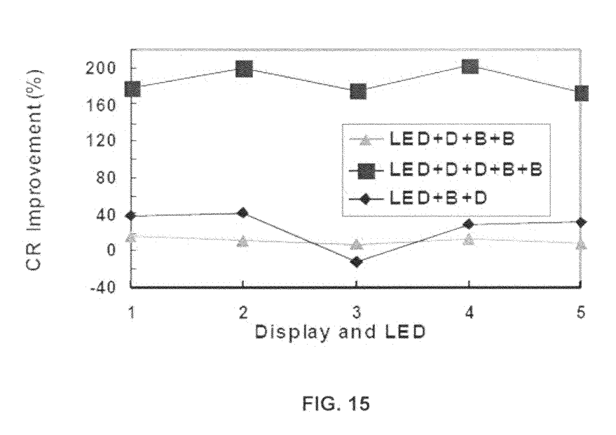

FIG. 14 shows measured brightness improvement for five displays for three different backlight designs: LED+D+B+B; LED+D+D+B+B; LED+B+D. The horizontal axis shows five different displays, with each curve showing the measured brightness improvement for 3 different backlights as compared to the standard LED backlight. The greatest improvement was achieved with crossed brightness enhancement films but with only a single diffuser, LED+D+B+B. The contrast ratio improvement for the same five displays is shown in FIG. 15 under the same three backlights. The backlight showing the greatest brightness improvement showed the smallest average contrast improvement, about 11%.

### Equivalents

While this invention has been particularly shown and described with references to preferred embodiments thereof, it will be understood by those skilled in the art that various changes in form and details may be made therein without departing from the scope of the invention encompassed by the appended claims.

What is claimed is:

1. A multi-domain vertical alignment display, comprising:
a) a plurality of repeats between a first substrate and a second substrate, each repeat including at least one full color pixel, each full color pixel including at least one color dot for each of red, blue and green, wherein each color dot includes:
i) a common electrode;
ii) a pixel electrode; and
iii) a liquid crystal component between the common electrode and the pixel electrode, the liquid crystal material having negative dielectric anisotropy,
wherein the common electrode is common among at least a portion of the repeats, and wherein color dots contiguous between at least two adjoining repeats in a row have different colors from each other;
b) a drive circuit causing color dots contiguous between at least two adjoining repeats in a row to have different polarities from each other.

2. The multi-domain vertical alignment display of claim 1, wherein said each color dot further includes a color filter material of red, blue or green.

3. The multi-domain vertical alignment display of claim 1, wherein at least one color dot of at least one repeat has a different polarity from the polarity of all neighboring contiguous color dots thereof.

4. The multi-domain vertical alignment display of claim 1, wherein the full color pixel is in an L-shape or a quadrilateral.

5. The multi-domain vertical alignment display of claim 4, wherein the full color pixel consists essentially of one red color dot, one green color dot and one blue color dot.

6. The multi-domain vertical alignment display of claim 4, wherein the quadrilateral is a trapezoid.

7. The multi-domain vertical alignment display of claim 4, wherein the quadrilateral is a parallelogram.

8. The multi-domain vertical alignment display of claim 7, wherein the full color pixel consists essentially of four color dots.

9. The multi-domain vertical alignment display of claim 8, wherein the full color pixel includes two color dots for one of red, blue and green.

10. The multi-domain vertical alignment display of claim 9, wherein the full color pixel includes two green color dots, one red color dot and one blue color dot.

11. The multi-domain vertical alignment display of claim 8, wherein the full color pixel includes white, red, green and blue color dots.

12. The multi-domain vertical alignment display of claim 1, wherein each repeat includes at least two full color pixels.

13. The multi-domain vertical alignment display of claim 12, wherein each repeat includes a pair of full color pixels, each of which is complementary to each other in shape.

14. The multi-domain vertical alignment display of claim 13, wherein the pair of full color pixels in combination form a square, rectangle or hexagon.

15. The multi-domain vertical alignment display of claim 1, wherein the common electrode is planar.

16. The multi-domain vertical display of claim 15, wherein each pixel electrode of at least one full color pixel is planar.

17. The multi-domain vertical alignment display of claim 1, wherein each color dot of at least one full color pixel has a plan dimension on each side of between about 3 μm and about 50 μm.

18. The multi-domain vertical alignment display of claim 16, wherein each color pixel of at least one full color pixel has dimensions of between about 5 μm×about 15 μm and about 15 μm×about 15 μm.

19. The multi-domain vertical alignment display of claim 18, wherein each color dot of at least one full color pixel has dimensions of about 7.5 μm×about 10 μm.

20. The multi-domain vertical alignment display of claim 18, wherein each color pixel of at least one full color pixel has dimensions of about 7.5 μm×about 7.5 μm.

21. The multi-domain vertical alignment display of claim 1, wherein each pixel electrode of at least one full color pixel is essentially quadrilateral.

22. The multi-domain vertical alignment display of claim 21, wherein each pixel electrode of at least one full color pixel is essentially square.

23. The multi-domain vertical alignment display of claim 1, wherein each color dot of at least one full color pixel creates a four-domain vertical alignment display.

24. The multi-domain vertical alignment display of claim 1, further including a first vertical liquid crystal alignment layer at the first substrate and a second vertical liquid crystal alignment layer at the second substrate, whereby the liquid crystal is between the first and second alignment layers.

25. The multi-domain vertical alignment display of claim 24, wherein the gap between the first and second vertical liquid crystal alignment layers is less than about 5 μm.

26. The multi-domain vertical alignment display of claim 24, wherein at least one of the first and second vertical liquid crystal alignment layers includes a polyimide layer.

27. The multi-domain vertical alignment display of claim 26, wherein at least one of the first and second vertical liquid crystal alignment layers includes a spin-on polyimide layer.

28. The multi-domain vertical alignment display of claim 1, further including an optical compensation film over each repeat of at least one full color pixel to improve the viewing angle of the display.

29. The multi-domain vertical alignment display of claim 28, wherein the optical compensation film is a negative birefringence anisotropic optical film.

30. The multi-domain vertical alignment display of claim 29, wherein the optical film is a uniaxial film or a biaxial film.

31. The multi-domain vertical alignment display of claim 1, further including a head mount supporting the plurality of repeats.

32. The multi-domain vertical alignment display of claim 1, wherein the display includes a display resolution of at least 320×240×3 dots.

33. A method of preparing a multi-domain vertical alignment liquid crystal display, comprising the steps of:
a) forming a plurality of repeats between a first substrate and a second substrate, each repeat including at least one full color pixel, each full color pixel including at least one color dot for each of red, blue and green, wherein each color dot includes:
i) a common electrode;
ii) a pixel electrode;
iii) a liquid crystal component between the common electrode and the pixel electrode, the liquid crystal material having negative dielectric anisotropy,
wherein the common electrode is common among at least a portion of the repeats, and wherein color dots contiguous between at least two adjoining repeats in a row have different colors from each other; and
b) forming a drive circuit causing color dots contiguous between at least two adjoining repeats in a row to have different polarities from each other.

34. The method of claim 33, wherein at least one color dot of at least one repeat has a different polarity from the polarity of all neighboring contiguous color dots thereof.

35. The method of claim 33, wherein each color dot has a plan dimension on each side of between about 3 μm and about 50 μm.

36. The method of claim 33, wherein the full color pixel is a parallelogram.

37. The method of claim 33, wherein each repeat includes at least two full color pixels.

38. The method of claim 37, wherein each repeat includes a pair of full color pixels, each of which is complementary to each other in shape.

39. The method of claim 38, wherein the pair of full color pixels in combination form a square, rectangle or hexagon.

40. The method of claim 33, wherein the first common electrode is planar.

41. The method of claim 40, wherein each pixel electrode of at least one full color pixel is planar.

42. The method of claim 33, further including the step of forming a color filter material of red, blue or green at the first substrate or the second substrate.

43. The method of claim 33, further including the step of forming a first vertical liquid crystal alignment layer at the first substrate and a second vertical liquid crystal alignment layer at the second substrate, whereby the liquid crystal is between the first and second alignment layers.

44. The method of claim 43, wherein at least one of the alignment layers includes a spin-on polyimide layer.

45. The method of claim 33, further including the step of forming a head mount supporting the plurality of repeats.
